(19) United States
(12) Patent Application Publication
(10) Pub. No.: US 2006/0069679 A1
(43) Pub. Date: Mar. 30, 2006

(54) System for creating associative records

(76) Inventors: Michael F. Percey, Elverson, PA (US); Allen N. Hole, West Chester, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/182,961

(22) Filed: Jul. 15, 2005

Related U.S. Application Data
(60) Provisional application No. 60/609,158, filed on Sep. 10, 2004.

(51) Int. Cl. G06F 7/00

(52) U.S. Cl. 707/6

(57) ABSTRACT

A system automatically produces records comprising an associative data structure specifying a relationship between two or more separate data structures in response to user entered selection criteria for individual separate data structures. A system for creating associative database records, includes a selection processor for selecting a first dataset in response to user command. A data processor, in response to user command, initiates a search to identify at least one second dataset linked to the first dataset. The data processor selects particular records of a particular second dataset of the identified at least one second dataset and initiates creation of a plurality of records associating the selected particular records of the particular second dataset with the first dataset. A storage processor stores the plurality of created records in a repository.

This is a non-provisional application of provisional application Ser. No. 60/609,158 by M. F. Percey et al. filed Sep. 10, 2004.

### FIELD OF THE INVENTION

This invention concerns a system for creating associative database records linking records of different datasets for use in structuring data of different types for access by a user.

### BACKGROUND OF THE INVENTION

A common task for an organization is to generate operational data for the products and services of the organization based on some recurring event. Such operational data is often dependent on the number of items involved and related combinations of detail. This task may require the generation of large numbers of records and sets of records. The definition and generation of a record set for a particular data structure is typically performed manually in existing systems by iteratively defining each new record using a Maintenance Function defined for the data structure. One existing system defines and creates such a record set by generating a flat file containing entries for each new required record and processing the file using a batch engine to generate the record set in a database, for example. The existing systems for generating the records comprising desired operational data are resource intensive, prone to error, and require significant time to complete. A system according to invention principles addresses these deficiencies and related problems.

### SUMMARY OF INVENTION

A system automates the generation of records for an associative data structure defining a relationship between two or more separate data structures (e.g., relational database data structures). A system for creating associative database records, includes a selection processor for selecting a first dataset in response to user command. A data processor, in response to user command, initiates a search to identify at least one second dataset linked to the first dataset. The data processor selects particular records of a particular second dataset of the identified at least one second dataset and initiates creation of a plurality of records associating the selected particular records of the particular second dataset with the first dataset. A storage processor stores the plurality of created records in a repository.

### BRIEF DESCRIPTION OF THE DRAWING

FIG. 1 shows a system for generating associative database records, according to invention principles.

FIG. 2 shows a high level associative data structure representation, according to invention principles.

FIG. 3 shows a system for generating associative database records in response to a record generation specification, according to invention principles.

FIG. 4 shows a user interface display image prompting a user to select a first data structure definition for which data records are to be generated, according to invention principles.

FIG. 5 shows a user interface display image presenting fields in the first data structure, according to invention principles.

FIG. 6 shows a user interface display image prompting a user to select a second data structure definition associated with the first data structure and for which data records are to be generated, according to invention principles.

FIG. 7 shows a user interface display image enabling a user to select data field search criteria for searching the selected second data structure, according to invention principles.

FIG. 8 shows a user interface display image presenting records derived in response to a performed data field search, according to invention principles.

FIG. 9 shows a user interface display image enabling a user to select another second data structure to be searched for data fields, according to invention principles.

FIG. 10 shows a user interface display image enabling a user to select criteria to filter data field search results, according to invention principles.

FIG. 11 shows a user interface display image presenting records comprising filtered data fields, according to invention principles.

FIG. 12 shows a flowchart of a process for generating associative database records, according to invention principles.

### DETAILED DESCRIPTION OF THE INVENTION

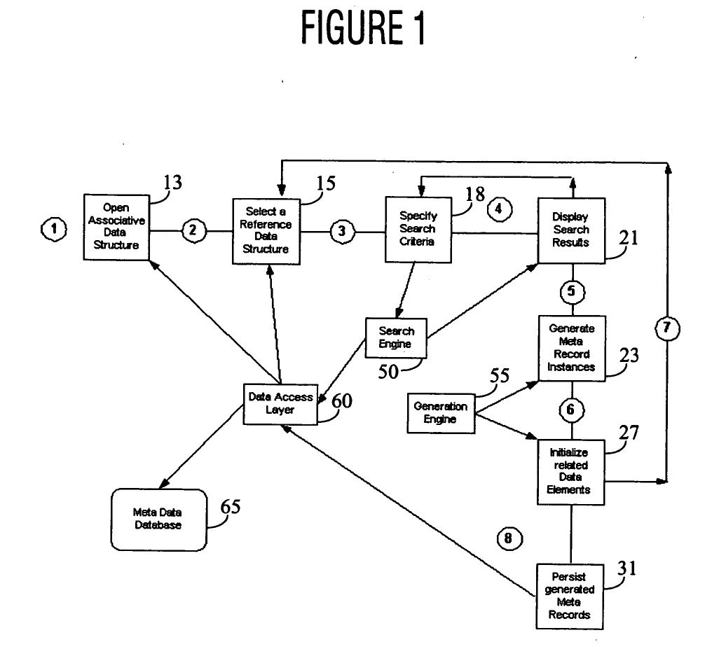

FIG. 1 shows a system for automatically generating records for an associative data structure determining a relationship between two or more separate data structures (e.g., relational database data structures). Information determining the structural relationship is maintained within the associative data structure. The system supports searching selected data structures based on user selected search criteria for individual data structures and advantageously creates a Cartesian (or Union) product, for example, of the separate data structures to automatically produce an associative data structure. The system advantageously automatically generates operational data with a reduced requirement for manual and computational resources. The system provides a user interface that supports the dynamic specification of search criteria to collect data from various record sets and uses this data to create a new record set. In response to user determination of default values, a new record set is automatically generated based on a search performed by a search function and the system stores the default value data in the new record set. This automatic record generation reduces the scope of data issues that need to be verified and resolved following record creation.

The system in one embodiment, is integrated with an application that supports user definition of data structures and stores data conforming to a user defined data structure. Specifically, in one embodiment, the system employs a database implementation that supports the use of meta-data to define a data structure (meta data structure) and records (meta records) are also stored in the database, and conform to the meta-data defined data structure.

An executable application as used herein comprises code or machine readable instruction for implementing predetermined functions including those of an operating system, healthcare information system or other information processing system, for example, in response user command or input. An executable procedure is a segment of code (machine readable instruction), sub-routine, or other distinct section of code or portion of an executable application for performing one or more particular processes and may include performing operations on received input parameters (or in response to received input parameters) and provide resulting output parameters. A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example.

A display processor or generator is a known element comprising electronic circuitry or software or a combination of both for generating display images or portions thereof. A user interface comprises one or more display images enabling user interaction with a processor or other device. Meta data as used herein comprises data determining a data structure (such as a tabular or record structure) including one or more data fields and encompasses data comprising ancillary data, attributes, referenced data and associated data of a Reference data structure such as a database, repository or table in a database or repository. Meta data may also comprise one or more data fields or records. A meta data structure as used herein is comprised of meta data and meta records. A meta record is comprised of meta data. A record is a structured compilation of data including one or more data fields in a database structure or tabular data structure, for example and individual data fields may be valued and include data elements. An associative record or associative database record, is a record including and associating data fields derived from at least two different datasets. A dataset is one or more of a database, table, or group of records. An instance of an executable application is a copy of an original executable application capable of concurrent execution using the same or different operational data. An instance of a record is a copy of an original record. An Associative Data Structure is one that contains references to one or more other data structures in its data definition.

The FIG. 1 system comprises one or more executable applications or portions of an executable application, for automatically generating data records for an associative data structure. For this purpose the system in step 13 initiates generation of data representing a display image presenting a list of associative data structures defined within an instance of an executable application in response to user command. A user selects an Associative Data Structure for which records are to be generated from the displayed list. Further, in step 15 the system initiates generation of data representing a display image presenting a list of data structures referenced in the Associative Data Structure definition enabling a user to select a particular Reference Data Structure.

The system in step 18 initiates generation of a display image enabling a user to determine search criteria for searching the particular Reference Data Structure previously selected by the user in step 13. The search criteria are selected to delineate the scope of data fields comprising the records identified in the particular Reference Data Structure and presented in search results. The search criteria may include predefined key fields within the particular Reference Data Structure as well as date restrictions regarding meta record maintenance activities, and the application state of the meta record. The search criteria are used by search engine 50, in conjunction with data access layer 60 (a DBMS (database management system)) facilitating data access to meta data database 65 in producing search results. In step 21, the system displays the set of records matching the defined search criteria. The user is able to review the set of records to verify that it meets expectations. If the set of records returned does not match expectations, the user is able to modify the search criteria and repeat the search.

In step 23, if the set of records presented in step 21 comprising the search results matches user expectations, a user is able to initiate generation of Record Instances. Generation engine 55 creates a new data record instance for individual unique data fields returned in the search result record set. Required initial data element values are created and incorporated by engine 55 in step 27 in data fields in the automatically generated new data record instances for the particular Reference Data Structure (associative data structure) previously selected by the user in step 13. If records already exist because of previous meta record generation, a user indicates whether a Cartesian Generation or a Union Generation process is to be used in the further generation of the data records for the particular Reference Data Structure (associative data structure).

A Cartesian Generation process employs a Cartesian Product of an existing meta record set and a search result record set. For example, if five data records already exist because of previous use of a meta record generation process, and seven unique data fields are present in reference records in a search result record set, thirty-five resultant records exist in response to generation of meta-records using a Cartesian Generation process since five new records are generated for each unique data field in the search result record set. A Union Generation process employs a union of an existing meta record set and a search result record set. For example, if five data records already exist because of previous use of a meta record generation process, and seven unique data fields are present in reference records in a search result record set, twelve records exist in response to generation of meta-records using a Union Generation process since seven new records are generated, one for each unique value in the search result record set. A user is able to edit the generated record set by copying element values between record instances, using a common default value for a specific data element in multiple record instances and editing individual data elements, for example.

The system in step 27 enables a user to repeat the process of steps 15-23 involving using generation engine 55 to generate a record set for a user selected particular Reference Data Structure referenced in an Associative Data Structure definition. This may be done for each of the individual Reference Data Structures referenced in the Associative Data Structure definition. An individual Reference Data Structure is used once in the meta record generation process. In step 31 in response to generation of a record set and incorporating values in created data fields as required, the generated record set is stored in database 65 via data access layer 60. This is performed in response to user command entered via a selected menu option that causes the system to iteratively process generated record sets and store the generated record sets in database 65 via data access layer 60. In another embodiment, the FIG. 1 system automatically generates data records for an associative data structure in response to predetermined instruction in a data generation specification, for example, and without manual interaction.

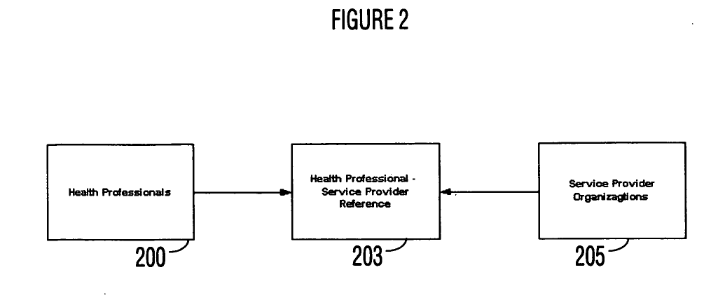

The system advantageously supports the bulk creation of associative data between data files such as master data files comprising a comprehensive set of data records employed by an executable application. In a healthcare application, for example, typically a healthcare system maintains a Heath Professional master file, containing data identifying doctors, nurses, clinicians etc. in an organization, and a Service Provider master file, containing patient treatment locations. These are reference data structures. During an operation to convert master data files from a first data format to another different data format, supplemental master files are often created. In an example, a Health Professional-Service Provider Reference supplemental master file is to be created. The supplemental master file 203 is an associative data structure as illustrated in FIG. 2 which identifies the relationship between Health Professionals 200 and the Service Providers 205 with which they are associated.

Associative master files are typically created in known systems via data entry, a record at a time. This is a burdensome and time-consuming process. In contrast, the inventive system supports automatic dynamic generation of the supplemental master file (an associative data structure), using existing reference master files (reference data structures). The automatic record generation system significantly reduces the amount of manual time required during an associative data structure generation and master file data format conversion process.

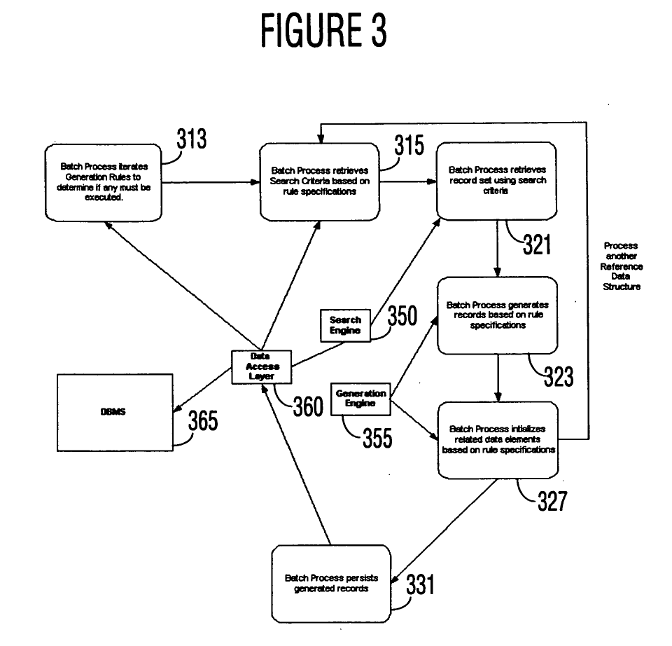

FIG. 3 shows a system for automatically updating master files by generating associative database records in response to a record generation specification. Associative master files that define relationships between primary master files may become divergent. This occurs because primary master files are maintained and updated during executable application processing and unless these updates are translated (to ensure compatibility with the associative master files) and provided to associative master files derived from the primary master files, the associative master files diverge from the primary master files. For example, whenever Health Professionals master file 200 (FIG. 2) is updated via an application, the Health Professional—Service Provider Reference master file 203 contains divergent associations unless file 203 is also updated in a compatible manner.

The system of FIG. 3 comprises an executable application supporting automatic batch processing, for example, exclusive of manual interaction, that ensures associative master files are maintained and kept synchronized with the contents of primary master files. The system performs the process shown in FIG. 3 in response to a Record Generation Specification that includes criteria and instructions determining, system execution, reference data structures, search criteria for each Reference Data Structure used by an Associative Data Structure, reference data structure relationships and default values for generated records. The system employs a batch-processing engine (not shown) that interprets the Record Generation Specification and controls the batch workflow (task sequence). The system in step 313 iterates through data generation rules and executes particular generation rules in response to the Record Generation Specification.

The system in step 315 retrieves search criteria for searching a particular Reference Data Structure referenced in an Associative Data Structure definition. The search criteria are retrieved from the Record Generation Specification. In step 321, search engine 350 uses the retrieved search criteria to perform a search of the particular Reference Data Structure in database (and database management system) 365 via data access layer 360. Specifically, the search criteria delineate the scope of data field records identified in the particular Reference Data Structure comprising the search results. The search criteria may include predefined key fields within the particular Reference Data Structure as well as date restrictions regarding meta record maintenance activities, and the application state of the meta record.

In step 323, generation engine 355 creates new record instances incorporating individual unique data fields returned in the search result record set in response to instructions in the Record Generation Specification. The new record instances created by generation engine 355 are populated as required with initial data element values in step 327. If records already exist because of previous meta record generation, the Record Generation Specification initiates use of a Cartesian Generation or a Union Generation process by engine 355 in the further generation of data records for the particular Reference Data Structure. The system in step 327 automatically repeats the process of steps 315-327 involving generating a record set for a user selected particular Reference Data Structure referenced in an Associative Data Structure definition. This may be done for each of the individual Reference Data Structures referenced in the Associative Data Structure definition. An individual Reference Data Structure is used once in the record generation process. In step 331 in response to generation of a record set and incorporating values in created data fields as required, the generated record set is stored in database 365 via data access layer 360. This is performed in response to user command entered via a selected menu option that causes the system to iteratively process generated record sets and store the generated record sets in database 365 via data access layer 360.

The system allows the specification of data elements within a data structure definition as being defined by a reference to data values within another different data structure. In an example of operation, data structures are defined by an enterprise that licenses storefront retailing opportunities throughout the United States. A Storefronts data structure tracks the locations of storefronts that the enterprise has licensed across the United States. A States data structure contains entries for each state in the United States and related attributes that the enterprise is interested in. Address information entered in the Storefronts data structure includes a State attribute as a reference to the States data structure. Thereby the system facilitates new record creation identifying an appropriate state where a storefront is located.

In another example, the system enables a user to dynamically generate data structure records based on reference relationships defined between the data structures. In this example, an enterprise business is an importer of automobiles providing distribution to dealerships throughout the United States. In another embodiment, the records are automatically generated in response to instructions and data in a Record Generation Specification without user interaction. The enterprise database contains reference data structures used to track information specific to particular data objects, and business data structures that manage data related to business objects. The following data structures are involved in this example

1). A Prices data structure used to track detail information regarding automobile model pricing. In the automobile distribution business, the price of an automobile is based on the automobile model and the sales region of the dealer. The Prices data structure contains element references to the Models and Regions data structures.

2). A Models reference data structure that tracks the various models (and related information) imported and distributed by the enterprise.

3). A Region reference data structure that defines the various business regions in the United States serviced by the enterprise.

At the start of each fiscal year, the reference data structures need to be updated with the business data for the coming year. This includes generating a Prices file indicating dealer cost for each model based on its regional distribution. Without the advantageous functions provided by the system, a user needs to manually create a record for each combination of model and sales region. For example, if the enterprise distributed thirty five automobile models and the dealer distribution network is split into fifteen sales regions, the user needs to create five hundred twenty five new records for the Prices data structure. In response to requirements of other specific application, these types of scenarios can readily require the generation of thousands, and tens of thousands of records.

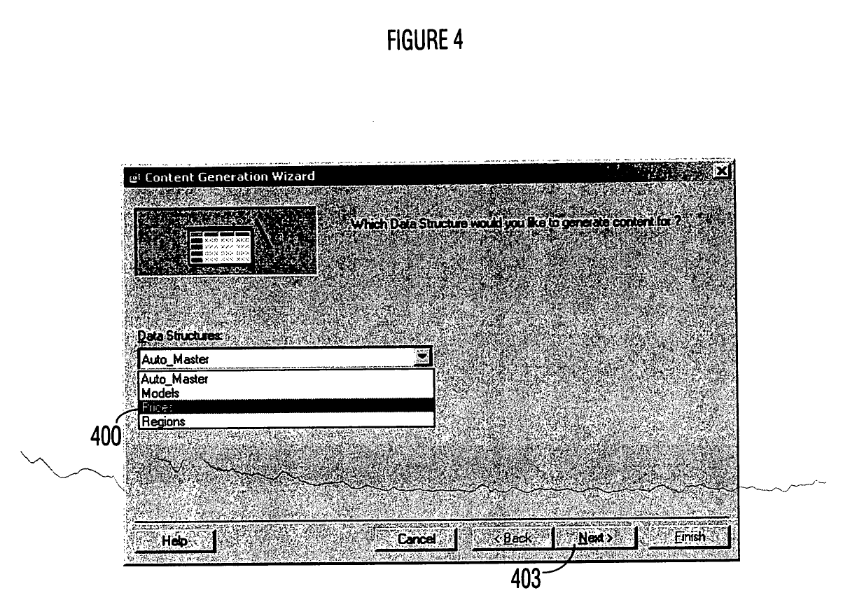

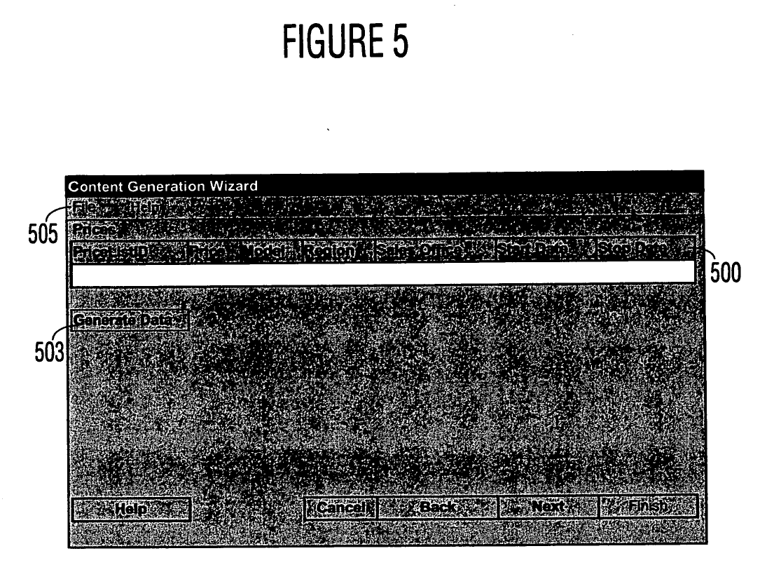

The system automates the task of creating new records using the process of FIG. 1 which initiates generation of the user interface display image of FIG. 4 (in step 15) prompting a user to select a particular Reference Data Structure definition, from multiple different data structure definitions, for which data records are to be generated. A user selects Prices data structure definition 400 using the FIG. 4 display image, for example, and selects Next button 403. In response, a user interface display image shown in FIG. 5 presenting data fields in the Prices Reference data structure in row 500 is displayed and includes an image element 503 enabling a user to initiate generation of data records. Additional image elements allowing a user to specify which elements should be displayed during generation of data records, as well as default values that are to be incorporated in particular generated data records, are accessible via a menu displayed in response to selection of button 505.

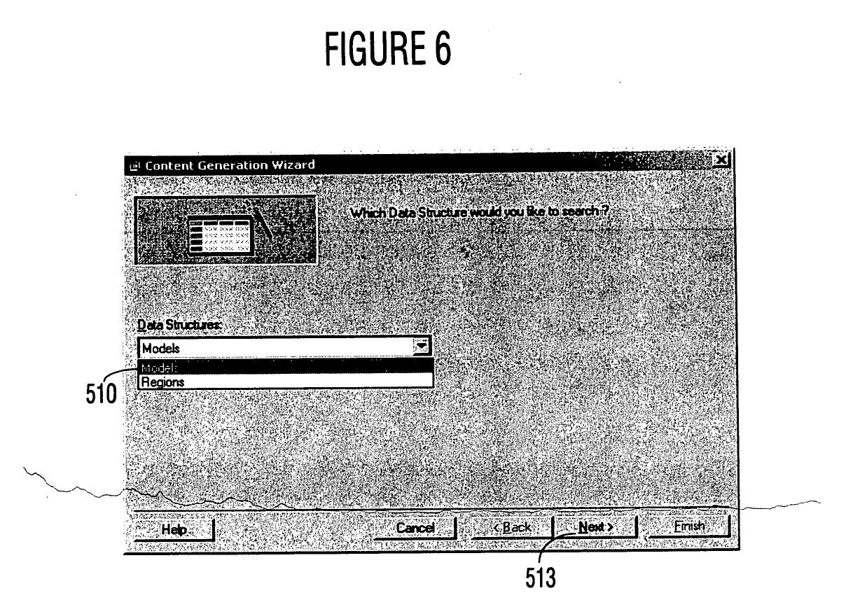

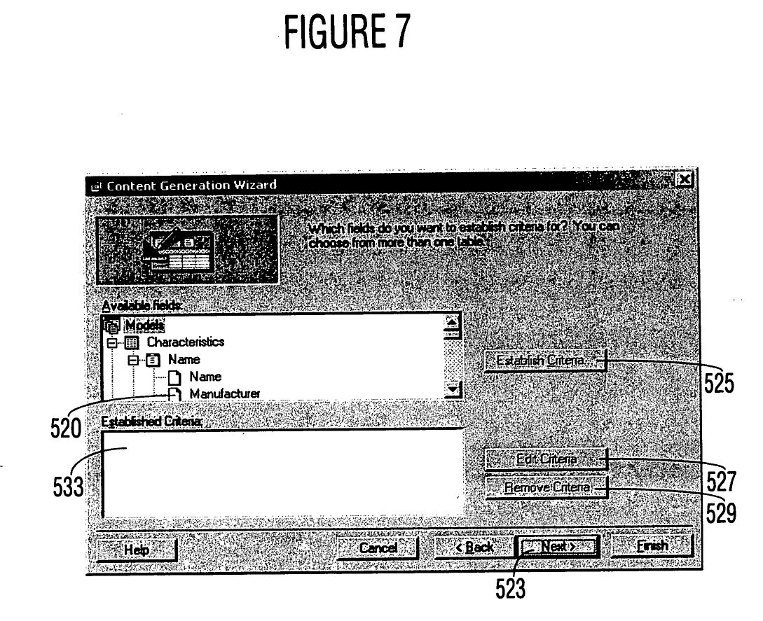

In response to user selection of button 503 in the display image of FIG. 5 initiating data record generation, the system displays a Search user interface display image (e.g., in step 18 of FIG. 1) enabling a user to determine search criteria for searching the Prices Reference Data Structure. The search criteria display image illustrated in FIG. 6 enables a user to select one or more data structures referenced in the Prices Reference Data Structure to be searched. The data structures referenced in the Prices Reference Data Structure include PriceListID, Price, Model, Region, Sales Office, Start Date and Stop Date shown in row 500 of FIG. 5. A user selects the Models reference data structure 510 in FIG. 6 and selects Next button 513. The system allows a user to define data element based criteria to limit the data returned by a search. A user may choose to define criteria to limit the results, or to display results (e.g., in step 21 of FIG. 1) using the user interface image of FIG. 7 displayed in response to user selection of Next button 513 of FIG. 6. A user is able to generate records (e.g., in step 23 of FIG. 1) grouped by Manufacturer 520 (FIG. 7) by highlighting of item 520 and selection of search criteria to be applied in searching the Manufacturer data structure. The applied search criteria is established by entry of the criteria in window 533 and selection of criteria establishment button 525 in the FIG. 7 display image. A user is able to edit the selected search criteria via a menu displayed in response to user selection of button 527 and is able to delete search criteria by selection of button 529. In this example, a user establishes Honda as the particular Manufacturer search criteria and selects Next button 523.

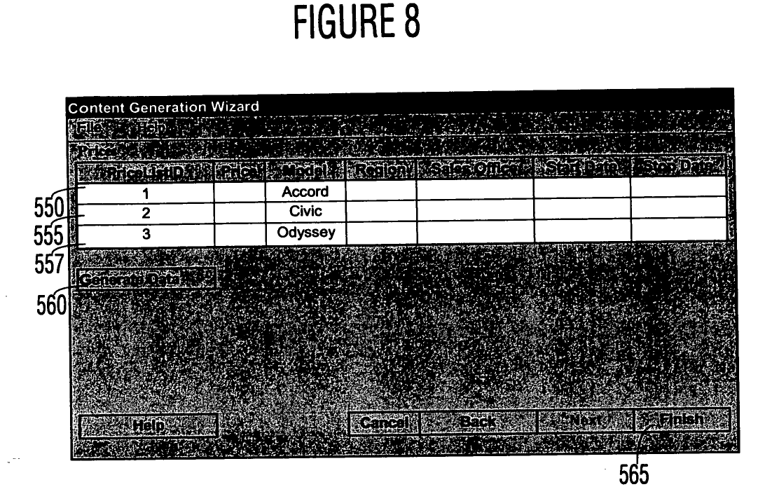

In response to user selection of Next button 523 in the FIG. 7 display image, the system performs a search of the Manufacturer data structure using the criteria (Honda) specified by the user. Based on the search result data set, the system creates a new data record for individual data records in the search result data set. Specifically, the system creates data records 550, 555 and 557 (shown in FIG. 8) for the three Models (Accord, Civic and Odyssey) found in the search of the Manufacturer data structure for Honda. The created records shown in the FIG. 8 display image include default values (e.g., in step 27 of FIG. 1) in the data fields that were previously assigned default values. For instance, a user may select a default Start Date as the start of the enterprise fiscal year and the Start Date data fields of records 550, 555 and 557 would contain that value. A user is able to edit the data in the FIG. 8 image display and selects either Generate Data button 560 or Finish button 565. In this example, a user continues with the data generation and selects Generate Data button 560.

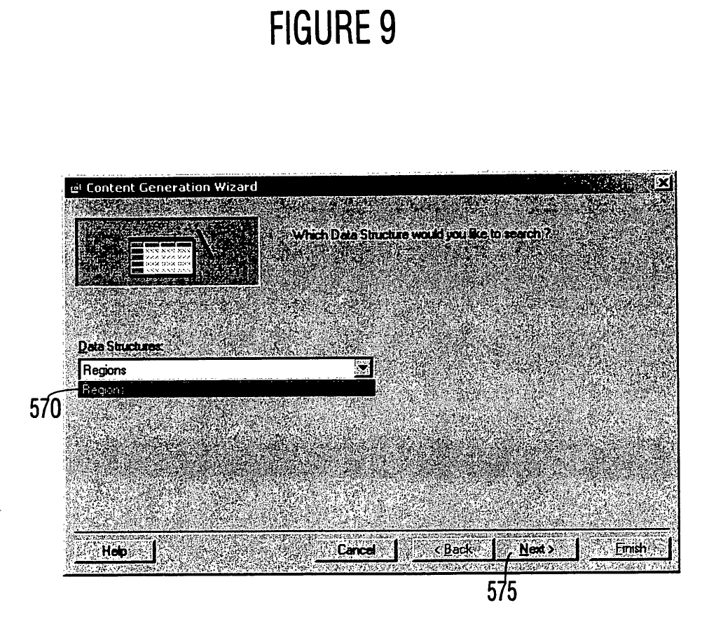

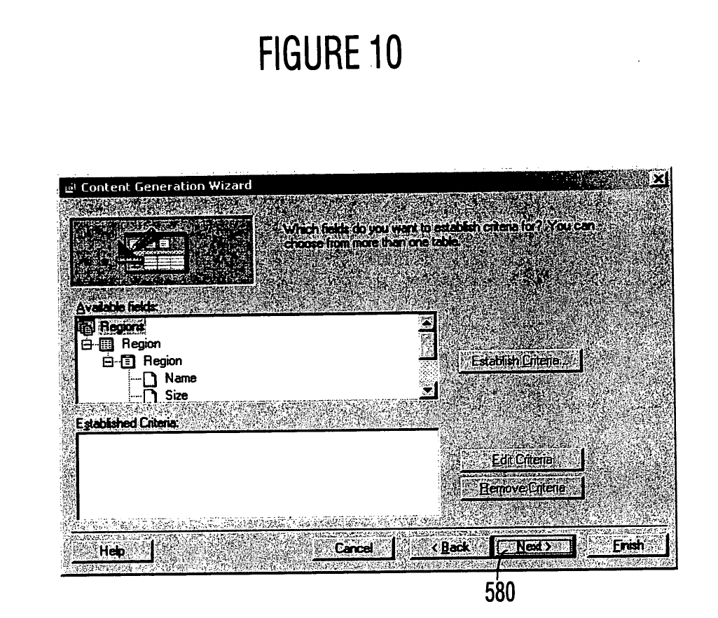

In response to user selection of the Generate Data button 560, the system displays the Search user interface display image of FIG. 9 enabling a user to choose from those data structures referenced by the Prices Reference Data Structure. The available choices comprise those data structures that were not previously searched, therefore the Regions data structure 570 is available. The user selects Regions data structure 570 and selects Next button 575 which prompts the system to initiate display of the image of FIG. 10 enabling a user to define data element based search criteria to filter data returned by the search. The FIG. 10 image enables a user to define criteria to limit the search results, or to display the results. A user is able to select search criteria and use the FIG. 10 image display to generate records based on a search of the Regions data structure grouped by Manufacturer and incorporating predetermined default values, for example. This may be done in a similar manner to that previously described in connection with FIG. 7. In this example, a user initiates display of results, or sales regions defined by an enterprise, and selects Next button 580.

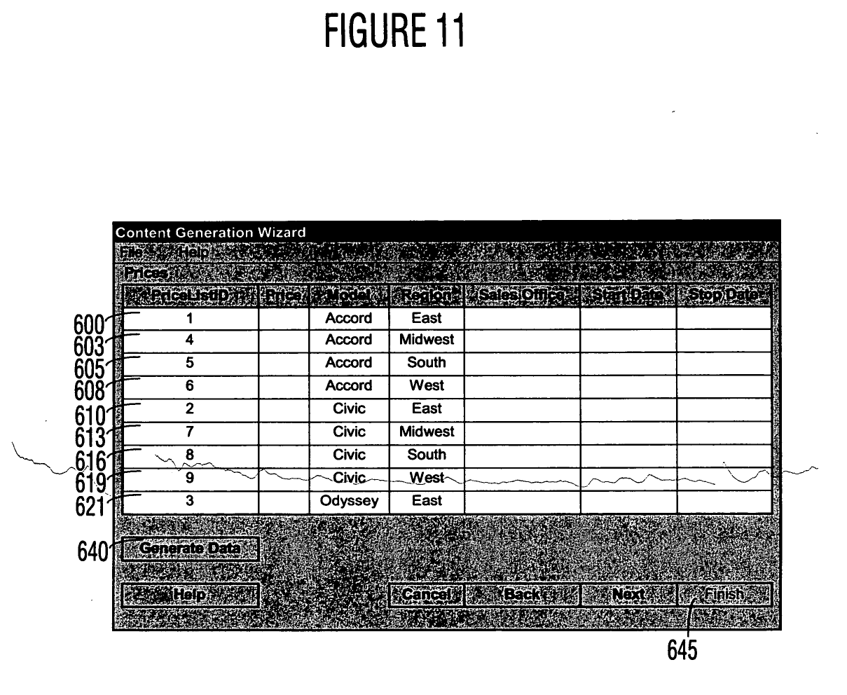

The system performs a search of the Regions data structure using criteria specified by a user via the FIG. 10 display image to provide a search result data set. The system creates a new record for each search result data field value. Further, because there already exists data records 550, 555 and 557 (shown in FIG. 8) for the three Models (Accord, Civic and Odyssey) found in the search of the Manufacturer data structure for Honda, the system creates a combination of new records. Specifically, for each of the records 550, 555 and 557, the system creates a new record for each data field value in the Regions data structure search result data set. In this example, four Regions (East, West, North, and South) are found in the Regions data structure search result set. Therefore, because three records 550, 555 and 557 already exist, a new record for each Regions data structure search result set data field value is created for each existing record. This results in twelve new records, nine of which are shown in rows 600-621 of the display image of FIG. 11. The system incorporates default values in the data fields of the created records in response to predetermined configuration information. A user is able to edit the created data records and select either Generate Data button 640 or Finish button 645 (among others). The system stores the newly created records in database 65 (e.g., in step 31 of FIG. 1).

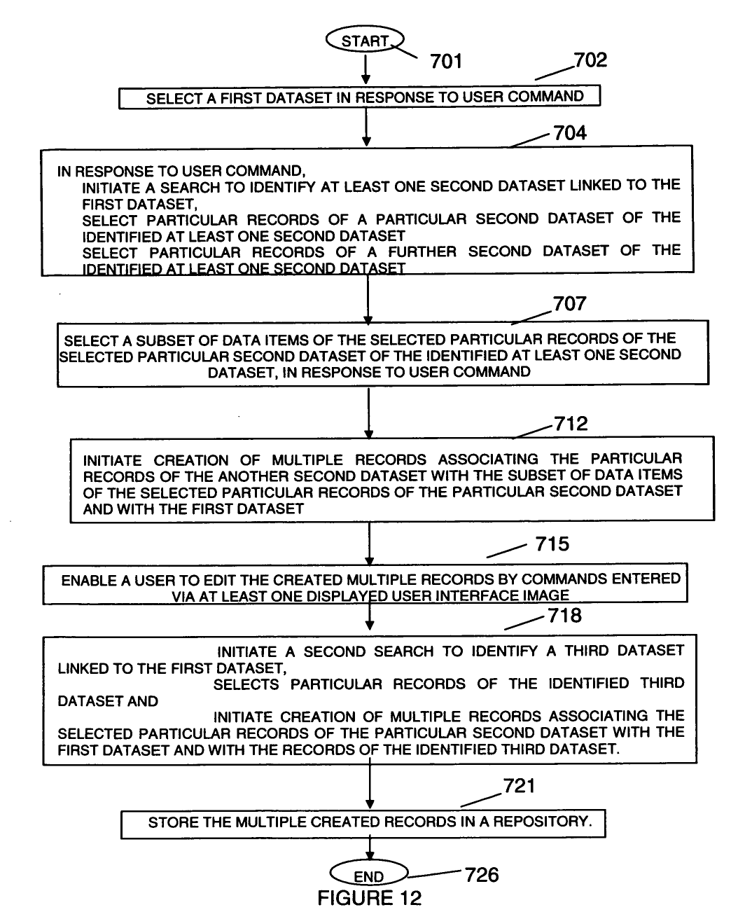

FIG. 12 shows a flowchart of a process performed by a system comprising one or more executable applications for generating associative database records. In step 702 following the start at step 701, the system selects a first dataset in response to user command. In step 704, the system, in response to user command, initiates a search to identify at least one second dataset linked to the first dataset, selects particular records of a particular second dataset of the identified at least one second dataset and selects particular records of a further second dataset of the identified at least one second dataset. The particular second dataset and further second dataset comprise first and second members of the multiple datasets linked to the first dataset. The system in response to user command in step 707 selects a subset of data items of the selected particular records of the selected particular second dataset of the identified at least one second dataset. The selected subset of data items comprise at least one of, data elements, data fields of the selected particular records and ancillary database meta data associated with the selected particular records. Such ancillary database meta data comprises one or more of, (a) database key data and (b) database index data, for example. In step 712 the system initiates creation of multiple records associating the particular records of the further second dataset with the selected subset of data items of the selected particular records of the particular second dataset and with the first dataset using a union generation function or a Cartesian generation function (or other generation function), for example. The system in step 715 enables a user to edit the created multiple records by commands entered via at least one displayed user interface image.

In step 718 the system, in response to user command, initiates a second search to identify a third dataset linked to the first dataset, selects particular records of the identified third dataset and initiates creation of multiple records associating the selected particular records of the particular second dataset with the first dataset and with the records of the identified third dataset. The system stores the multiple created records in a repository in step 721 and the process of FIG. 12 terminates at step 726. In another embodiment, the steps of the process of FIG. 12 (or one or more individual steps) are performed automatically in response to predetermined instruction instead of in response to user command. Instructions comprising an executable application for performing the process of FIG. 12 may be incorporated in a tangible storage medium.

The system enables a user to determine which elements to include in a user interface display image and displays created data records in an easy to modify grid format, for example, and automates maintenance of an application. Executable applications use references supporting data structures in business object data structures. The system uses these references together with an integrated search mechanism to support the generation of new records and provide user-friendly data definition support. The system allows a user to define default element values, to easily copy element values across data fields (e.g., cells) and edit the values within the data fields.

Business data structures typically contain references to reference data structures. The system employs business data structures that act as collections of data comprising combinations of sets of data from reference data structures to automate the process of data structure initialization. The system is usable to support a wide range of data processing applications and database management applications. The system is usable to generate a master file of healthcare (or other) data including physician, laboratory, service, procedural and related data, during update and conversion of an existing application to a new application.

The system, processes and user interface display images presented herein are not exclusive. Other systems and processes may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. Further, any of the functions provided by the system and process of FIGS. 1, 3 and 12, may be implemented in hardware, software or a combination of both.

What is claimed is:

1. A system for creating associative database records, comprising:
a selection processor for selecting a first dataset in response to user command;
a data processor for, in response to user command,
initiating a search to identify at least one second dataset linked to said first dataset,
selecting particular records of a particular second dataset of said identified at least one second dataset and
initiating creation of a plurality of records associating said selected particular records of said particular second dataset with said first dataset; and
a storage processor for storing said plurality of created records in a repository.

2. A system according to claim 1, wherein
said data processor in response to user command,
selects particular records of another second dataset of said identified at least one second dataset and
initiates creation of said plurality of records associating said particular records of said another second dataset with said selected particular records of said particular second dataset and with said first dataset.

3. A system according to claim 1, wherein
said data processor in response to user command,
selects a subset of data items of said selected particular records of said selected particular second dataset of said identified at least one second dataset and
initiates creation of a plurality of records associating said selected subset of data items of said selected particular records of said selected particular second dataset, with said first dataset.

4. A system according to claim 3, wherein
said selected subset of data items comprise at least one of, (a) data elements and (b) data fields of said selected particular records.

5. A system according to claim 3, wherein
said selected subset of data items comprises ancillary database meta data associated with said selected particular records.

6. A system according to claim 5, wherein
said ancillary database meta data comprises at least one of, (a) database key data and (b) database index data.

7. A system according to claim 1, including
an edit processor enabling a user to edit said created plurality of records by commands entered via at least one displayed user interface image.

8. A system according to claim 1, wherein
said data processor initiates creation of said plurality of records associating said selected particular records of said particular second dataset with said first dataset using a union generation function.

9. A system according to claim 1, wherein
said data processor initiates creation of said plurality of records associating said selected particular records of said particular second dataset with said first dataset using a Cartesian generation function.

10. A system according to claim 1, wherein
said data processor, in response to user command,
initiates a second search to identify a third dataset linked to said first dataset,
selects particular records of said identified third dataset and
initiates creation of a plurality of records associating said selected particular records of said particular second dataset with said first dataset and with said records of said identified third dataset.

11. A system for automatically creating associative database records, comprising:
a data processor for, in response to a selected first dataset, automatically,
initiating a search to identify at least one second dataset linked to said first dataset,
selecting particular records of a particular second dataset of said identified at least one second dataset and
initiating creation of a plurality of records associating said selected particular records of said particular second dataset with said first dataset; and
a storage processor for storing said plurality of created records in a repository.

12. A user interface system supporting creating associative database records, comprising:
a display processor for initiating generation of data representing at least one display image enabling a user, in response to user command, to
select a first dataset,
initiate a search to identify at least one second dataset linked to said first dataset,
select particular records of a particular second dataset of said identified at least one second dataset and
initiate creation of a plurality of records associating said selected particular records of said particular second dataset with said first dataset; and
a storage processor for storing said plurality of created records in a repository.

13. A system for creating associative database records, comprising:
a selection processor for selecting an initial dataset in response to user command;
a data processor for, in response to user command,
initiating a search to identify a plurality of datasets linked to said first dataset,
selecting first and second members of said plurality of linked datasets,
selecting particular records of first and second members of said plurality of linked datasets and
initiating creation of a plurality of records associating said first and second members of said plurality of linked datasets with said first dataset; and
a storage processor for storing said plurality of created records in a repository.

14. A system for creating associative database records, comprising:
a selection processor for selecting an initial dataset in response to user command;
a data processor for, in response to user command,
initiating a search to identify a plurality of datasets linked to said first dataset,
selecting first and second members of said plurality of linked datasets,
selecting particular records of said first and second members of said plurality of linked datasets,
select a subset of data items of said first and second members of said plurality of linked datasets and
initiating creation of a plurality of records associating said selected subset of data items of said first and second members of said plurality of linked datasets with said first dataset; and
a storage processor for storing said plurality of created records in a repository.

15. A method for creating associative database records, comprising the activities of:
selecting a first dataset in response to user command;
in response to user command,
initiating a search to identify at least one second dataset linked to said first dataset,
selecting particular records of a particular second dataset of said identified at least one second dataset and
initiating creation of a plurality of records associating said selected particular records of said particular second dataset with said first dataset; and
storing said plurality of created records in a repository.

16. A tangible storage medium incorporating an executable application for performing the activities of claim 15.
